(19) United States
(12) Patent Application Publication
(10) Pub. No.: US 2006/0002557 A1
(43) Pub. Date: Jan. 5, 2006

(54) Domain name system (DNS) IP address distribution in a telecommunications network using the protocol for carrying authentication for network access (PANA)

(76) Inventor: Lila Madour, Kirkland (CA)

Correspondence Address: ALEX NICOLAESCU;Ericsson Canada Inc., Patent Department (EMC/QM/P), 8400 Decarie Blvd., Town Mount Royal, QC, H4P 2N2, CA

(21) Appl. No.: 11/015,021

(22) Filed: Dec. 20, 2004

Related U.S. Application Data
(60) Provisional application No. 60/584,160, filed on Jul. 1, 2004.

(51) Int. Cl. H04K 1/00

(52) U.S. Cl. 380/270

(57) ABSTRACT

A method, a packet data switching node such as for example a CDMA2000 Packet data Serving Node (PDSN), and a Mobile Node (MN) for assigning one or more DNS IP addresses to the MN in a telecommunications network. The switching node and the MN are first involved in a discovery phase, and then the MN sends a Protocol for Carrying Authentication for Network Access (PANA) Start-Answer message to the switching node with a request for a DNS IP address. The switching node receives the PANA Start-Answer message and recognizes the request for the DNS IP address. It authenticates the MN, possibly in combination with an Authentication, Authorization, and Accounting (AAA) server, and if the authentication is successful, assigns a primary DNS IP address and a secondary DNS IP address for the MN, and responds back to the MN with a PANA Bind-Request message comprising one or more assigned DNS IP addresses.

### PRIORITY STATEMENT UNDER 35 U.S.C. S.119(e) & 37 C.F.R. S.1.78

This non-provisional patent application claims priority based upon the prior U.S. provisional patent application entitled “QSA: PPP Free Operation”, application No. 60/584,160, filed Jul. 01, 2004, in the name of Lila MADOUR.

### BACKGROUND OF THE INVENTION

1. Field of the Invention

The present invention relates to a method and system for distributing a Domain Name System (DNS) IP address to a Mobile Node (MN).

2. Description of the Related Art

CDMA2000, also known as IMT-CDMA Multi-Carrier or IS-95, is a Code-Division Multiple Access (CDMA) version of the IMT-2000 standard developed by the International Telecommunication Union (ITU). The CDMA2000 standard is a third-generation (3 G) mobile wireless technology allowing mobile nodes (e.g. mobile stations, wireless PDAs, etc) to access IP-based high-speed voice and data traffic over the CDMA-based cellular network. CDMA2000 can support mobile data communications at speeds ranging from 144 Kbps to 2 Mbps.

In order to fully recognize the advantages of the present invention, a short description of some technical concepts associated with CDMA2000 IP-based cellular telecommunications networks is required. A typical CDMA2000 network comprises a number of nodes including a plurality of Mobile Nodes (MNs), a plurality of Base Stations (BSs), one or more Packet Control Functions (PCFs) and one or more Packet Data Serving Nodes (PDSNs), or their equivalent. The BSs may be connected to the PCF, which is an entity in the CDMA2000 Radio Access Network (RAN) that controls the transmission of data packets between the BSs and the PDSN. The PCF is in turn connected with the PDSN.

In a CDMA2000 network, the PDSN provides access to the Internet, intranets and applications servers for MNs utilizing the CDMA2000 RAN. Acting as an access gateway, the PDSN provides simple IP and mobile IP access, Foreign Agent (FA) support, and packet transport for virtual private networking. It may also act as a client for an Authorization, Authentication, and Accounting server (AAA) and provides the MNs with a gateway to the IP network.

The AM server of a CDMA2000 network intelligently controls access to network resources, enforces policies, audits the usage, and provides the information necessary to bill for the services accessed by the MNs. These combined processes are essential for effective network management and security.

In CDMA2000 networks, the Point-to-Point Protocol (PPP) is used for setting up data session between the MNs and the serving PDSN. PPP is a protocol for communication between two nodes using a serial interface. PPP uses the Internet Protocol (IP) and thus it is sometimes considered a member of the TCP/IP suite of protocols. Relative to the Open Systems Interconnection (OSI) reference model, PPP provides layer 2 (data-link layer) service. Essentially, it packages a computer's TCP/IP packets and forwards them to a server where they can actually be put on the Internet. The use of PPP in CDMA2000 networks is defined in the Internet Engineering Task Force (IETF) Request for Comments (RFC) 1661, which is herein included by reference in its entirety, as a link layer protocol between the MN and the PDSN for the establishment of packet data sessions. In CDMA2000 networks, four types of packet data sessions may be established using PPP: Simple IPv4, Mobile IPv4, Simple IPv6 and Mobile IPv6, on which work in still in progress.

Recently, the 3G Partnership Project 2 (3GPP2) has accepted a work item that proposes elimination of PPP from the CDMA2000 packet data system and its replacement with an IP level signaling for at least the following motivations:

PPP is a very old technology mainly designed for wire-line dial-up services and 3GPP2 is considering upgrading to a better-suited protocol;

High-Level Data Link Control (HDLC) like framing is a processor intensive task: according to a study made by Qualcomm Inc. for broadcast multicast service, HDLC-like framing is 62 times more computational intensive compared to packet based framing, which has been adopted as an option to support broadcast/multicast service in 3GPP2. The MN and the PDSN utilize a processor intensive procedure whereby they parse received data on an octet-by-octet basis for HDLC flags to determine higher layer packet boundaries. This operation could be rather performed at a hardware level. However, this requires the platform hardware to support HDLC, which is not the case with current PDSNs; and

PPP is based on peer-to-peer negotiation, which may cause high call setup delay times. According to a recent benchmark, the average PPP call setup time is about 2.5 seconds, which is inappropriate for most applications used in CDMA2000 networks.

However, there is no other existing IETF-based protocol that provides all the capabilities of PPP, i.e. link layer negotiation, header compression negotiation, IP address configuration, packet data session termination, and link layer echo test. Other protocols have recently been identified as IP access based protocols that may represent an alternative to PPP, but each one lacks one or more of the capabilities of PPP.

Recently, the IETF has considered using the Protocol for Carrying Authentication for Network Access (PANA) as one of these possible replacements for PPP for setting up data sessions in CDMA2000 networks. PANA involves two entities, a PANA Authentication Client (PAC) in the MN and a PANA Authentication Agent (PAA) in the PDSN, or connected thereto. An Enforcement point (EP) is just an Access Router that provides per packet enforcement policies applied on the inbound and outbound traffic of the MN, although in some case the EP may be implemented in the PDSN itself. PANA, as defined today in the IETF draft, is limited to carry Extensible Authentication Protocol (EAP) authentication between the PAC and the AAA through the PAA. Any EAP method can be transported, including the methods that allow bootstrapping for other protocols in the access network for encryption and data integrity, if so required by the operator.

It is known that in most cases access networks require some form of authentication in order to prevent unauthorized usage. In the absence of physical security (and sometimes in addition to it), a higher layer (L2+) access authentication mechanism is needed. Depending on the deployment scenarios, a number of features are expected from the authentication mechanism. For example, support for various authentication methods (e.g., MD5, TLS, SIM, etc.), network roaming, network service provider discovery and selection, separate authentication for access (L1+L2) service provider and Internet Service Provider (ISP, L3), etc. In the absence of a link-layer authentication mechanism that can satisfy these needs, operators are forced to either use non-standard ad-hoc solutions at layers above the link, insert additional shim layers for authentication, or misuse some of the existing protocols in ways that were not intended by design. PANA is proposed to be developed to fill this gap by defining a standard network-layer access authentication protocol. As a network-layer access authentication protocol, PANA can be used over any link-layer that supports IP.

PPP-based authentication could provide some of the required functionality. But using PPP only for authentication is not a good choice, as it incurs additional messaging during the connection setup and extra per-packet processing, and it forces the network topology to a point-to-point model. There is now an interest in the CDMA2000 community to remove PPP from some of the existing architectures and deployments.

The goal of PANA is to define a protocol that allows clients, such as MNs of a CDMA2000 network, to authenticate themselves to the access network using IP protocols. Such a protocol would allow a client to interact with a MA infrastructure to gain access without needing to understand the particular AM infrastructure protocols that are in use at the site. It would also allow such interactions to take place without a link-layer specific mechanism. PANA would be applicable to both multi-access and point-to-point links. It would provide support for various authentication methods, dynamic service provider selection, and roaming clients. Mobile IPv4 developed its own protocols for performing PANA-like functions (e.g., MN-Foreign Agent (FA) interaction). Mobile IPv6 does not have the equivalent of an FA that would allow the access/visited network to authenticate the MN before allowing access. The PAA can perform the authentication function attributed to the FA in Mobile IPv4, in Mobile IPv6 networks. Work is currently being performed with PANA with the assumption that a PAC is already configured with an IP address before using PANA. This IP address will provide limited reachability to the PAC until it is authenticated with the PAA. Upon successful authentication, the PAC is granted broader network access possibly by either a new IP address assignment, or by enforcement points changing filtering rules for the same IP address.

Conclusively, PANA is being developed into an IP-based protocol that allows a device to authenticate itself with the network (and to a PAA in particular) in order to be granted network access. In order to better understand the use of PANA, a short explanation of the PANA usual terminology may be appropriate:

PANA Session:

A PANA session begins with the initial handshake between the PANA Client (PaC) and the PANA Authentication Agent (PAA), and terminates by an authentication failure, a timeout, or an explicit termination message. A fixed session identifier is maintained throughout a session. A session cannot be shared across multiple physical network interfaces. A distinct PANA session is associated with the device identifiers of PAC and PAA.

Session Identifier:

This identifier is used to uniquely identify a PANA session on the PAA and PAC. It includes an identifier of the PAA, therefore it cannot be shared across multiple PAAs. It is. included in PANA messages to bind the message to a specific PANA session. This bi-directional identifier is allocated by the PAA following the initial handshake and freed when the session terminates.

PANA Security Association:

A PANA security association is a relationship between the PAC and PAA, formed by the sharing of cryptographic keying material and associated context. Security associations are duplex. That is, one security association is needed to protect the bi-directional traffic between the PAC and the PAA.

PANA Client (PAC):

The client side of the protocol that resides in the host device, which is responsible for providing the credentials to prove its identity for network, access authorization.

Device Identifier (DI):

The identifier used by the network as a handle to control and police the network access of a client. Depending on the access technology, this identifier might contain any of IP address, link-layer address, switch port number, etc of a connected device.

PANA Authentication Agent (PAA):

The protocol entity in the access network side whose responsibility is to verify the credentials provided by a PANA client and grant network access service to the device associated with the client and identified by a DI. Note the authentication and authorization procedure can, according to the EAP model, be also offloaded to the backend AAA infrastructure.

Enforcement Point (EP):

A node on the access network where per-packet enforcement policies (i.e., filters) are applied on the inbound and outbound traffic of client devices. Information such as the DI and (optionally) cryptographic keys are provided by the PAA per client for constructing filters on the EP.

Network Access Provider (NAP):

A service provider that provides physical and link-layer connectivity to an access network it manages.

AAA-Key:

A key derived by the EAP peer and EAP server and transported to the authenticator.

In its current form, PANA lacks capabilities for insuring a proper alternative to PPP for the setup of data session in CDMA2000 networks. For example, PANA does not define mechanisms and functions currently provided by PPP, such as IP address configuration, security, and header compression mechanisms. Nor does PANA allow for the distribution of a Domain Name Server (DNS) IP address to the terminal. Consequently, PANA as defined in IETF today is not sufficient, and additional capabilities, are required to convert it from just a transport mechanism for EAP packets into a suitable IP access protocol.

A DNS is a system that allows the translation of Internet domain names into Internet Protocol addresses. A domain name is a meaningful and easy-to-remember “handle” for an Internet address. Examples of domain names are www.yahoo.com www.msn.com, and the likes. Because maintaining a central list of domain name/IP address correspondences would be impractical, the lists of domain names and IP addresses are distributed throughout the Internet in a hierarchy of authority. There is a DNS server within close geographic proximity to every Internet access provider that maps the domain names of Internet requests issued by users, or forwards them to other servers in the Internet.

When an MN registers with the CDMA2000 telecommunications network, the MN must be also provided with at least one DNS address, which the MN stores in its internal memory. Then, the MN uses the DNS IP address to issue Internet requests, such as for example a request to connect to a specific Internet server. In the prior art, the DNS IP address provision was made via the Dynamic Host Configuration Protocol (DHCP). However, instances arise when DHCP is impractical, because of the heavy signaling it involves, or cannot be used. In such instances, an alternative way of distributing DNS IP address is needed.

Although the industry is resolved to get rid of PPP, no optimized PANA signaling has been proposed so far for the distribution of the appropriate DNS address to the MN. Conclusively, so far no call scenarios have been proposed for assigning a DNS IP address to the MN.

Accordingly, it should be readily appreciated that in order to overcome the deficiencies and shortcomings of the existing solutions, it would be advantageous to have a method and system for efficiently providing a DNS IP address to a CDMA2000 mobile terminal. The present invention provides such a method and system.

### SUMMARY OF THE INVENTION

In one aspect, the present invention is a method for sending a Domain Name Server (DNS) IP address to a Mobile Node (MN) in a telecommunications network, the method comprising the steps of:

i) selecting at least one DNS IP address for transmission to the MN; and

ii) sending from the packet data switching node to the MN a first Protocol for Carrying Authentication for Network Access (PANA) message comprising the at least one DNS IP address for the MN.

In another aspect, the present invention is a packet data switching node for assigning at least one DNS IP address to a Mobile Node (MN) in a telecommunications network, the packet data switching node comprising:

a memory storing at least one DNS IP address;

a Protocol for Carrying Authentication for Network Access (PANA) Authentication Agent (PAA) module;

wherein the PDSN selects the at least one DNS IP address for transmission to the MN, and the PANA module issues to the MN a first PANA message comprising the at least one DNS IP address for the MN.

In yet another aspect, the present invention is a Mobile Node (MN) comprising:

a Protocol for Carrying Authentication for Network Access (PANA) Authentication Client (PAC) module;

a memory for storing at least one Domain Name Server (DNS) IP address;

wherein the PAC module receives a first PANA message comprising the at least one DNS IP address for the MN, extracts the at least one DNS IP address and stores the at least one DNS IP address in the memory.

### BRIEF DESCRIPTION OF THE DRAWING

For a more detailed understanding of the invention, for further objects and advantages thereof, reference can now be made to the following description, taken in conjunction with the accompanying drawings, in which:

FIG. 1 is an exemplary nodal operation and signal flow diagram representing a Code Division Multiple Access 2000 (CDMA2000) telecommunications network implementing the preferred embodiment of the present invention; and

FIG. 2 is an exemplary representation of a Protocol for Carrying Authentication for Network Access (PANA) Bind-Request message carrying the Domain Name Server (DNS) IP address according to the preferred embodiment of the present invention.

### DETAILED DESCRIPTION OF THE PREFERRED EMBODIMENT

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

In order to alleviate the use of Point-to-Point Protocol (PPP) in Code Division Multiple Access 2000 (CDMA2000) networks, the present invention proposes to replace PPP by an IP based protocol for packet data access and Mobile Node (MN) configuration. More precisely, the invention relies on using the Protocol for Carrying Authentication for Network Access (PANA), with added enhancements and functionalities, in order to assign one or more Domain Name Server (DNS) IP address to an MN that registers with the CDMA2000 network.

To use PANA, a PANA client (PAC) in the MN and a PANA Authentication Agent (PAA) in the serving Packet Data Serving Node (PDSN) are typically required. According to the invention, the PAC and the PAA first establish a PANA session, where the MN is authenticated and authorized. Currently PANA does not support the assignment of a DNS IP address to a Mobile Node (MN) since, at the present moment, IETF suggests using the Dynamic Host Configuration Protocol (DHCP) for the MN's configuration. However, using DHCP creates heavy signaling on the network's resources, which induces delays in the establishment of an IP data session.

Upon a new registration, the MN must be configured with at least one Domain Name System (DNS) IP address, so that Internet requests issued by the MN can be directed to the DNS for resolving their IP address, thus permitting to the Internet requests to be directed to the appropriate Internet server.

In order to fulfill this need without the heavy signaling imposed by the use of DHCP, the current invention defines a method and system for providing one or more DNS IP addresses to the MN though the use of PANA. For this purpose, a request for such a DNS IP address may be sent from the MN to the PDSN. Currently, PANA does not support such functionality. To alleviate this problem, the current invention proposes to include an indication that a DNS IP address is requested into a PANA Start-Answer message sent from the MN to the serving PDSN. Upon receipt of the message with the indication, the PDSN recognizes the request for the DNS IP address received from the MN, and responsive thereto, authenticates the MN. If the authentication is successful, the PDSN further assigns a DNS IP address to the requesting MN. The assigned DNS IP address(es) is/are then returned to the MN in a PANA Bind-Request message.

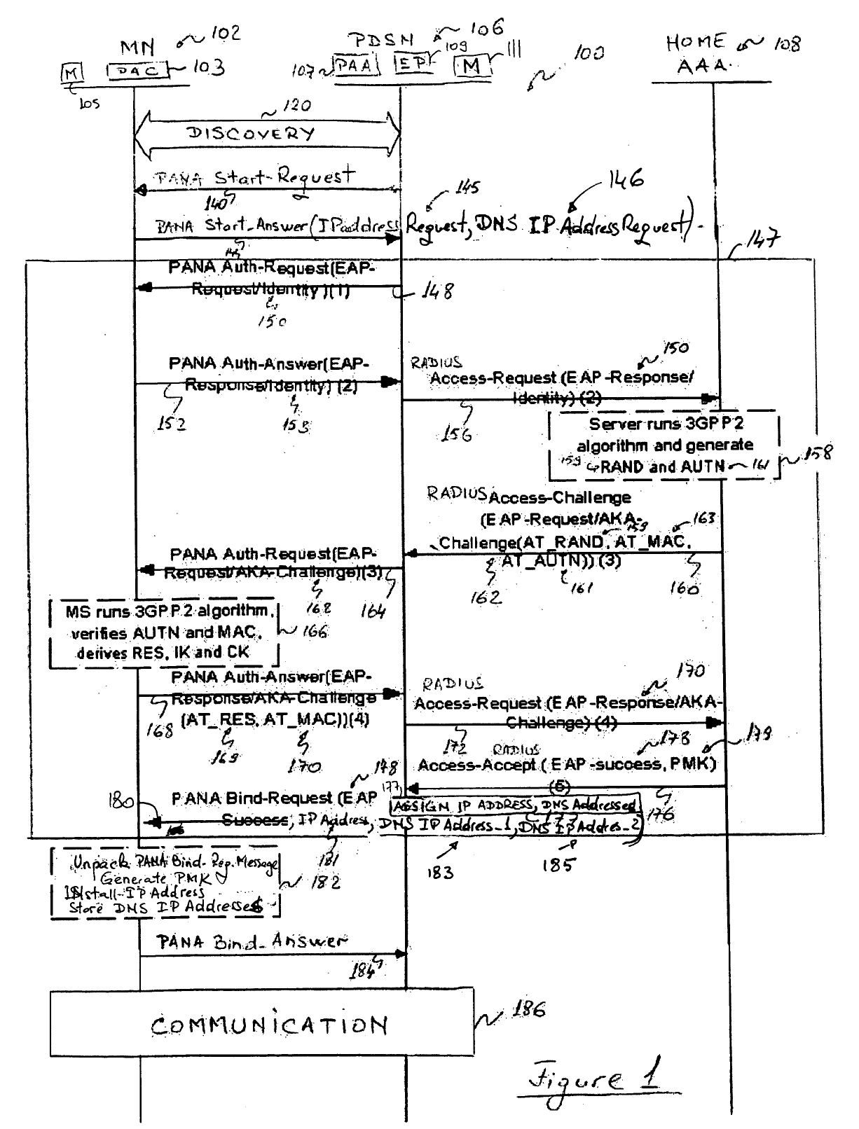

Reference is now made to FIG. 1, which is an exemplary nodal operation and signal flow diagram representing a CDMA2000 telecommunications network 100 implementing the preferred embodiment of the present invention. Shown in FIG. 1, is first a CDMA2000 MN 102 that implements a PAC module 103, which is provided CDMA2000 radio coverage by a Base Station (BS, not shown for simplicity purposes), which is further connected to a CDMA2000 serving PDSN 106 that comprises a PAA module 107 and an Enforcement Point (EP) module 109. Finally, the PDSN 107 is connected to an Authentication, Authorization, and Accounting (AAA) server 108-responsible for the authentication and authorization of the MNs served by the PDSN 106.

According to the invention, the process starts in action 120 where a PANA discovery method is performed in order to discover a PAA for use by the MN 102. The discovery phase 120 may be performed using a PANA multicast PAA Discovery message sent from the PAA 107 of the PDSN 106 to the PAC 103 of the MN 102, or alternatively using a link layer indication that a new PAC is connected.

Once the discovery phase 120 is completed, the PAA 107 of the PDSN 106 sends to the PAC 103 of the MN 102 a PANA Start Request message 140 with parameters to indicate the beginning of the authentication phase and it includes a sequence number used to track the PANA messages that are exchanged. Responsive to the message 140, the PAC 103 of the MN 102 responds with a PANA Start Answer message 144 comprising an indication 145 that the MN 102 requests the assignment of an IP address from the PDSN 106, and optionally, a DNS IP address request 146. The PDSN 106 receives the message 144 with the DNS IP address request 146 and responsive thereto, before assigning the new IP address to the MN and the DNS IP address, starts an authentication 147 for the MN. Such authentication 147 may take various forms, as preferred by the operator of the network 100. For example, the PDSN 106 may use an EAP-based (Extensible Authentication Protocol) authentication method that enables key exchange to allow other protocols to be bootstrapped for securing the data traffic between the PDSN 106 and the MN 102 when CDMA2000 link layer encryption is not used. EAP-AKA (Authentication Key Agreement Protocol) could be used to generate a master session key, which is then sent to the PDSN in the case where the EP (Enforcement Point) is implemented within the PDSN, like in the present example.

The exemplary authentication 147 of the MN 102 with the network 100 may comprise first, a PDSN request message 148 for the user identity of the MN terminal 102, that may comprise a PANA Auth-Request message, which includes parameters 150 indicative of the requested MN identity. The PAC 103 of the MN 102 responds to message 150 with a PANA Auth-Answer message 152 comprising the terminal identity 153 (e.g., the terminal Network Access Identifier (NAI) of the MN 102). Upon receipt of the MN's identity in message 152, the PDSN 106 sends to the AM server 108 a RADIUS Access-Request message 156 containing an EAP packet 150 with the MN's identity 153. The home AM server 108 receives the message 156, decides that EAP-AKA authentication is suitable based on the user profile associated with the MN's identity 153, and generates a random value RAND 159 and AUTN value 161 based on a Shared Secret Key (SSK) MN-AM, which is part of the user profile stored in the AM 108, and also based on a sequence number, also stored in the MA, and which is used for AKA authentication vector generation, action 158. The AM server 108 sends back to the PDSN 106 a RADIUS Access-Challenge message 160 that comprises EAP-AKA Challenge information 162, i.e. the RAND 159, the AUTN 161, and a MAC attribute 163 to protect the integrity of the EAP message. The RADIUS message 160 is received by the PDSN 106, which extracts the EAP-AKA challenge information 162 from the RADIUS message, and sends it further to the MN 102 in a PANA Auth-Request message 164.

The MN 102 verifies the AUTN 161 and the AT—MAC attribute 163, action 166, and if the verification is successful, it generates a response RES attribute 169 that is sent to the PDSN 106 via a PANA Auth-Answer message 168. The purpose of the RES attribute 169 is to allow the home AAA server 108 to authenticate the peer, since the MAC attribute 169 protects the integrity of the EAP packet. The PDSN 106 receives the message 168 and forwards this response (i.e. the AKA Challenge information 170 with the RES attribute 169) via a RADIUS Access-Request message 172 to the AAA server 108.

The home AAA 108 checks the AKA challenge information 170 received in message 172. If the authentication is successful, the MA server 108 sends a RADIUS Access-Accept message 176 transporting an EAP-Success parameter 178, which informs the PDSN 106 that the MN 102 is successfully authenticated. The AAA server 108 also generates a Pairwise Master Key (PMK) 179 by using, for example, the first 32 bytes of a master key generated based on the user identity, CK (Cipher Key) and IK (Integrity Key), which are session keys generated for the session using the SSK (Shared Secret Key). The AM 108 sends the PMK parameter 179 to the PDSN 106 in the same message 176. Upon receipt of message 176, the PDSN 106 stores the PMK 179 and uses it to generate an IKE pre-shared key for subsequent IKE exchange.

The PDSN 106, which is informed in message 176 of the successful authentication of the MN 102, now first assigns (selects) an IP address 181 for the MN 102, action 177, which may comprise the selection of an available IP address from the PDSN's pool of available IP addresses. Secondly, in action 177 further selects one or more DNS IP addresses to be sent to the MN 102 from an internal memory 111 of the PDSN that stores one or more DNS IP addresses. The DNS IP addresses may be either permanently stored in the memory 111, or alternatively may be received from the Home AAA server 108 and stored in the memory 111, or yet further be received from a visited AAA server. Typically, the PDSN 106 selects a primary DNS IP address and a secondary DNS IP address from the memory 111. The PDSN 106 then sends a PANA Bind request message 180 comprising i) the indication 178 informing the MN 102 of the successful authentication, ii) the IP address 181 that is assigned to the MN 102, and iii) the assigned one or more DNS IP addresses, such as for example the primary DNS IP address 183 and the secondary DNS IP address 185.

In action 182, the PAC 103 of the MN 102 MN 102 receives the PANA message 180, which it unpacks to retrieve the EAP-Success indication 178, the IP address 181 assigned to the MN, and the DNS IP addresses 183 and 185. Based on the IKE pre-shared key, the MN 102 also generates in action 182 the PMK, installs the assigned IP address 181, and stores the primary DNS IP address 183 and the secondary DNS IP address 185 into an internal memory 105, thus configuring itself with DNS addresses for use with Internet requests.

Following successful authentication 147, the PDSN 106 and the MN 102 each has a PMK, which they use to generate the IKE pre-shared key using, for example, the following algorithm:
IKE Pre-shared Key=HMAC-SHA-1 (PMK, “IKE-preshared key” |Session ID | Key-ID | EP-address).

Session ID: The value as defined in the PANA protocol and identifies a particular session of a client.

Key-ID: This identifies the PMK within a given PANA session. During the lifetime of the PANA session, there could be multiple EAP re-authentications. As EAP re-authentication changes the PMK, key-ID is used to identify the right PMK.

EP address: This is the IP address of the EP (assumed to be collocated with the PDSN) with which IKE key exchange is being performed.

IKE (v1 or v2) is then exchanged and IPsec SAs are established between the MS and the EP (PDSN).

Finally, in action 184, the MN 102 answers to the PDSN 106 with a PANA Bind Answer message that informs the PDSN of the success of the authentication, and in action 186 packet data communication may take place between the MN 102 and the PDSN 106. Action 186 may comprise the sending of Internet requests by the MN 102, which requests are sent to the primary DNS IP address stored in the MN's memory 105.

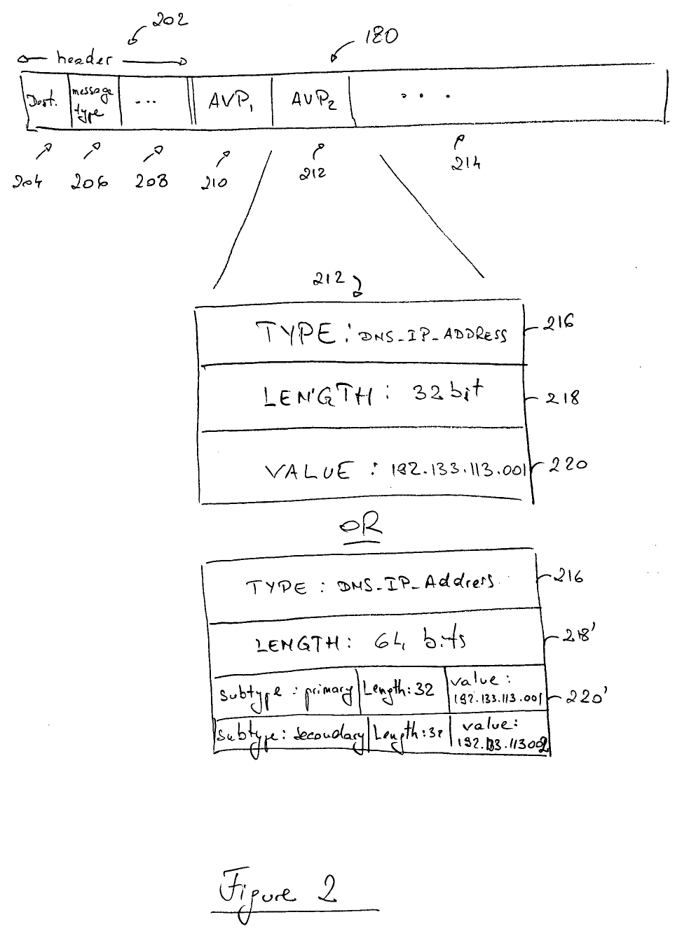

Reference is now made to FIG. 2, which is an exemplary representation of the PANA Bind-Request message 180 carrying the DNS IP address(es) (183 and/or 185) according to the preferred embodiment of the present invention, which message has already been briefly described with reference to FIG. 1. Shown in the FIG. 2, is an exemplary structure of the PANA Bind-Request message 180. The message 180 first comprises a message header 202 that includes a destination address 204 of the recipient (e.g. the recipient's IP address), a message type 206 indicative of the type of the message “Bind-Request”, and possibly other type of information 208. The body of the message 180 typically comprises a plurality of Attribute Value Pairs (AVPs) segments 210, 212, and 214 that contain various pieces of information. For example, the AVP 212 comprises the DNS IP address(es) sent by the PDSN 106 to the MN 102 in FIG. 1. According to a first variant of the structure of the AVP, the AVP 212 comprises a type indication 216 that indicates that the AVP contains a DNS IP address, a length indication 218 indicative of the AVP's length of 32 bits, and a value indication 220 that contains the DNS IP address itself. This first variant may be used when transmitting one single DNS IP address to the MN 102, or when transmitting two or more DNS IP addresses, in which case each such DNS IP address is included into an AVP of the message. Alternatively, according to a second variant of the structure of the AVP, two or more DNS IP addresses can be included into the same AVP of the message 180. In such a case, the AVP 212 comprises the same type indication 216 that indicates that the AVP contains DNS IP addresses, a length indication 218′ indicative of the AVP's length of 64 bits, and a value indication 220′ that contains two (or more) DNS IP addresses. In this case, the value field 220′ is split in two (or more). For example, a first subtype indicates that the first value is a primary DNS IP address, its length is of 32 bits, and its value is 192.133.113.001. A second subtype indicates that the second value is a secondary DNS IP address, its length is of 32 bits and its value is 192.133.113.002.

The PANA Bind-Request message structure described with reference to FIG. 2 can be advantageously employed for the message 180 to carry the one or more DNS IP addresses from the PDSN 106 to the MN 102.

Therefore, with the present invention it becomes possible to optimize the packet data session setup time for the user by assigning DNS IP addresses to the MN during the PANA session exchange, instead of using, for example, the more fastidious DHCP protocol.

Based upon the foregoing, it should now be apparent to those of ordinary skills in the art that the present invention provides an advantageous solution, which offers considerable signaling optimization compared to using DHCP for acquiring a DNS IP address after the PANA session establishment is completed. Although the system and method of the present invention have been described in particular reference to CDMA2000, it should be realized upon reference hereto that the innovative teachings contained herein are not necessarily limited thereto and may be implemented advantageously with any other access technology that uses PANA as an access interface It is believed that the operation and construction of the present invention will be apparent from the foregoing description. For example, the invention can also be implemented in General Packet Radio Service or Universal Mobile Telephone Service (GPRS/UMTS) networks, and in such a case, the PDSN 106 shown in FIG. 1 would be rather a Serving GPRS Support Node (SGSN) or a Gateway GPRS Support Node (GGSN). Such nodes, are designates generically in the following claims as packet data switching nodes. While the method and system shown and described have been characterized as being preferred, it will be readily apparent that various changes and modifications could be made therein without departing from the scope of the invention as defined by the claims set forth hereinbelow.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for sending a Domain Name Server (DNS) IP address to a Mobile Node (MN) in a telecommunications network, the method comprising the steps of:
i) selecting at least one DNS IP address for transmission to the MN; and
ii) sending from the packet data switching node to the MN a first Protocol for Carrying Authentication for Network Access (PANA) message comprising the at least one DNS IP address for the MN.

2. The method claimed in claim 1, further comprising the steps of:
iii) before step i), receiving at the packet data switching node a second PANA message comprising a request for a DNS IP address.

3. The method claimed in claim 1, wherein:
the first PANA message includes a PANA Bind-Request message.

4. The method claimed in claim 2, wherein the second PANA message comprises a PANA Start-Answer message.

5. The method claimed in claim 3, further comprising the steps of:
iv) responsive to step iii), initiating an authentication of the MN; and
v) if the authentication of the MN is successful, performing step i) and ii).

6. The method claimed in claim 1, further comprising the step of:
iii) performing an MN discovery of a PANA Authentication Agent (PAA) related to the packet data switching node prior to step i).

7. The method claimed in claim 1, wherein the telecommunications network comprises a CDMA2000 telecommunications network and wherein the packet data switching node comprises a CDMA2000 Packet Data Service Node (PDSN).

8. The method claimed in claim 3, wherein the at least one DNS IP address includes a primary DNS IP address and a secondary DNS IP address.

9. The method claimed in claim 3, wherein the at least one DNS IP address for the MN is included into an Attribute Value Pair (AVP) segment of the PANA Bind-Request message.

10. The method claimed in claim 8, wherein the primary DNS IP address and the secondary DNS IP address are included into an Attribute Value Pair (AVP) segment of the PANA Bind-Request message.

11. The method claimed in claim 8, wherein the primary DNS IP address and the secondary DNS IP address are each included into a different Attribute Value Pair (AVP) segment of the PANA Bind-Request message.

12. A packet data switching node for assigning at least one Domain Name Server (DNS) IP address to a Mobile Node (MN) in a telecommunications network, the packet data switching node comprising:
a memory storing at least one DNS IP address;
a Protocol for Carrying Authentication for Network Access (PANA) Authentication Agent (PAA) module;
wherein the PDSN selects the at least one DNS IP address for transmission to the MN, and the PANA module issues to the MN a first PANA message comprising the at least one DNS IP address for the MN.

13. The packet data switching node claimed in claim 12, wherein receiving the PANA module receives a second PANA message comprising a request for a DNS IP address before selecting the at least one DNS IP address.

14. The packet data switching node claimed in claim 12, wherein the first PANA message includes a PANA Bind-Request message.

15. The packet data switching node claimed in claim 13, wherein the second PANA message comprises a PANA Start-Answer message.

16. The packet data switching node claimed in claim 14, wherein the PDSN initiates an authentication of the MN responsive to the receipt of the PANA Start-Answer message, and if the authentication of the MN is successful, the PDSN selects the at least one DNS IP address and the PANA module issues the PANA Bind-Request message.

17. The packet data switching node claimed in claim 12, wherein an MN discovery of a PANA Authentication Agent (PAA) related to the packet data switching node is performed.

18. The packet data switching node claimed in claim 12, wherein the telecommunications network comprises a CDMA2000 telecommunications network and wherein the packet data switching node comprises a CDMA2000 Packet Data Service Node (PDSN).

19. The packet data switching node claimed in claim 14, wherein the at least one DNS IP address includes a primary DNS IP address and a secondary DNS IP address.

20. The packet data switching node claimed in claim 14, wherein the at least one DNS IP address for the MN is included into an Attribute Value Pair (AVP) segment of the PANA Bind-Request message.

21. The packet data switching node claimed in claim 19, wherein the primary DNS IP address and a secondary DNS IP address are included into an Attribute Value Pair (AVP) segment of the PANA Bind-Request message.

22. The packet data switching node claimed in claim 19, wherein the primary DNS IP address and a secondary DNS IP address are each included into a different Attribute Value Pair (AVP) segment of the PANA Bind-Request message.

23. A Mobile Node (MN) comprising:
a Protocol for Carrying Authentication for Network Access (PANA) Authentication Client (PAC) module;
a memory for storing at least one Domain Name Server (DNS) IP address;
wherein the PAC module receives a first PANA message comprising the at least one DNS IP address for the MN, extracts the at least one DNS IP address and stores the at least one DNS IP address in the memory.

24. The MN claimed in claim 23, wherein the MN sends to a packet data switching node a second PANA message comprising a request for a DNS IP address.

25. The MN claimed in claim 23, wherein the first PANA message includes a PANA Bind-Request message.

26. The MN claimed in claim 24, wherein the second PANA message comprises a PANA Start-Answer message.

27. The MN claimed in claim 23, wherein the MN comprises a CDMA2000 MN.

28. The MN claimed in claim 25, wherein the at least one DNS IP address includes a primary DNS IP address and a secondary DNS IP address.

29. The MN claimed in claim 25, wherein the at least one DNS IP address for the MN is included into an Attribute Value Pair (AVP) segment of the PANA Bind-Request message.

30. The MN claimed in claim 28, wherein the primary DNS IP address and the secondary DNS IP address are included into an Attribute Value Pair (AVP) segment of the PANA Bind-Request message.

31. The MN claimed in claim 28, wherein the primary DNS IP address and the secondary DNS IP address are each included into a different Attribute Value Pair (AVP) segment of the PANA Bind-Request message.
